(19) United States
(12) Patent Application Publication
(10) Pub. No.: US 2010/0158635 A1
(43) Pub. Date: Jun. 24, 2010

(54) Split Nut Assembly

(76) Inventor: Brian Rodman, El Dorado Hills, CA (US)

Correspondence Address: BULLIVANT HOUSER BAILEY PC, 1415 L STREET, SUITE 1000, SACRAMENTO, CA, 95814, US

(21) Appl. No.: 12/343,096

(22) Filed: Dec. 23, 2008

(51) Int. Cl. F16B 37/08

(52) U.S. Cl. 411/432

(57) ABSTRACT

The invention provides a female nut comprising a) an inner cylindrical member having first and second open ends, a threaded inner bore, and a non-threaded outer surface, where the cylindrical member is comprised of first and second longitudinally divided members, whereby the first and second divided members together form the cylindrical member; and b) an outer sheath having first and second open ends, a non-threaded inner bore and an outer surface, where the outer sheath fits over the assembled cylindrical member with the inner bore of the outer sheath in close contact with the outer surface of the cylindrical member and respective first open ends adjacent.

### BACKGROUND OF THE INVENTION

1. Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent files and records, but otherwise reserves all other copyright rights.

2. Field of the Invention

The subject invention is directed toward the art of the fittings and components used in high purity gas distribution systems and other ultra-high pressure systems such as those typically found within the high tech and semiconductor industries where the work area is constricted causing limitations in the ability to reach and maneuver persons and equipment.

3. Background Art

In the area of semiconductor manufacturing, wafer fabrication facilities are commonly organized to include areas in which chemical vapor deposition, plasma deposition, plasma etching, sputtering and the like are carried out. In order to carry out these processes, it is necessary for the tools and machines that are used for the processes to be provided with a precise amount of processing gases to enable the fabrication steps. In such processes for the manufacture semiconductors, various high purity gases can be used. These gases are controlled by systems composed of high purity valves, regulators, pressure transducers, mass flow controllers and other components connected together by welding and high purity metal seal fittings.

In a typical wafer processing facility, the inert and reactant gases are stored in tanks which may be located a distance from the wafer processing area and are connected via piping or conduit ultimately to a gas panel. The gas panel has the purpose of delivering precisely metered amounts of pure inert or reactant gas. A typical gas panel includes a numerous gas paths having connected therein literally hundreds of components, such as valves, filters, flow regulators, pressure regulators, pressure transducers, and connections, connected together by tens (or hundreds) of feet of tubing.

Gas panels are designed to provide numerous desired functions, such as gas transport, mixing and purging, by uniquely configuring the various individual components. The gas panel occupies a relatively large amount of space, as each of the components are plumbed into the gas panel, either through welding tubing to the devices or combinations of welds and connectors.

The elaborate constructions necessary for delivery of these gases are cumbersome to work in and around. For construction and maintenance, the tight quarters add time and cost for welding operations, and the necessarily tight spacing between components makes it difficult to replace a part. Further, these systems are typically custom designed and manufactured which makes the manufacturing costs and procurement of replacement parts quite expensive.

Welds are particularly expensive to make in such systems, as they take place in an inert atmosphere. The surfaces of the gas handling system that contact gas must be made as smooth and nonreactive as possible in order to reduce the number of sites where contaminants may tend to deposit in the tube, leading to the formation of particulates or dust which could contaminate the wafers being processed.

Additional problems relate to the fact that such a welded system of the type currently used today requires a significant amount of space between each of the components so that during servicing the connections can be accessed and opened. In addition, in order to remove a section or portion of a contemporary gas panel, many of the supports of the surrounding parts must be loosened so that the hardware can be spread out to allow removal of the item under consideration.

For example, a typical gas panel is located in the cabinet with the tool and typically occupies a relatively large amount of space, as each of the active devices are plumbed into the gas panel, either through welding tubing to the devices or combinations of welds and connectors such as VCR connectors or the like (a available from Cajon Corporation and others, for example). In a combination VCR connector and welded tubing system the individual components are held on shimmed supports to provide alignment prior to connections at VCR fittings. Misalignment at a VCR fitting can result in leakage.

In addition, it has been found that VCR fittings often tend to come loose in transit and some gas panel manufacturers assume that the VCR fittings have loosened during transit, possibly admitting contaminants to the system.

Additional problems relate to the fact that a combination VCR and welded system of the type currently used today typically requires a significant amount of space between each of the components so that during servicing the VCR connections can be accessed and opened. In addition, in order to remove an active component from a contemporary gas panel, many of the supports of the surrounding components must be loosened so that the components can be spread out to allow removal of the active component under consideration.

Coupling glands are usually associated with other components of ultra-high pressure systems including the widely used VCR fittings. For example, the ends of the glands are remote from the sealing end faces and are secured to fluid lines, pressure regulators, valves, etc. As will also be recognized by those skilled in the art, these types of fluid couplings are often used in ultra pure environments, where high degrees of cleanliness are required.

Accordingly, steps must be taken, for example, when a welded interconnection is made between the first gland and the fluid component to address the cleanliness problem. Likewise, requirements imposed by semiconductor chip manufacturers have forced fluid coupling suppliers to evaluate all components, and portions of components, of the coupling assemblies in an effort to meet the particle standards.

Coupling assemblies for the transmission of gases or fluids that may be secured together by axial movement of a male coupling into a female coupling are known in the art. While several methods are commonly used to connect the male coupling to the flexible conduit, such as a barbed hose adapter, the female coupling is typically connected to a standard female threaded port in the apparatus.

Manufacturers of coupling assemblies have attempted to reduce complexity and cost by integrating the female coupling directly into their customer's apparatus (known as “direct porting”), thereby eliminating the need for the standard female threaded port. However, customers are oftentimes reluctant to integrate a particular coupling manufacturer's female coupling directly into their apparatus because doing so would make it difficult to convert back to a standard female threaded port. Additionally, customers may be reluctant to integrate a particular manufacturer's female coupling directly into the apparatus because doing so would require them to purchase all their replacement hoses from the coupling manufacturer. There are continual efforts to improve upon the current designs of coupling assemblies, particularly to reduce the complexity and cost of coupling assemblies as well as to design couplings that are compatible with standard fittings (e.g., a standard female threaded port).

Couplings produced as a split-nut adaptor system are less prevalent in the art. U.S. Pat. No. 5,605,358 to Mohlenkamp, provides a female split-nut fitting assembly where the female component is located in a hex collar that fits over a threaded male component. The seal on this VCR assembly is made when a gasket compresses two gland components and a metal annular gasket between a body hex and a female nut. Similar prior art is disclosed in U.S. Pat. No. 5,636,876 to Eidsmore.

None of the prior approaches have been able to effectively address the spatial limitations in the manufacture of ultra-high pressure systems, particularly those used in the semiconductor industry, where a welding step may be required.

### SUMMARY OF THE INVENTION

The subject invention is provides an advanced fitting system for high purity gas distribution systems and other ultra-high pressure systems. While the invention is useful for high tech and semiconductor industries, the problem of restricted access is apparent in other industries and applications, anywhere where the fittings require a welding step where the work area is constricted causing limitations in the ability to reach and maneuver persons and equipment.

More particularly, the invention provides a female nut comprising a) an inner cylindrical member having first and second open ends, a threaded inner bore, and a non-threaded outer surface, where the cylindrical member is comprised of first and second longitudinally divided members, whereby the first and second divided members together form the cylindrical member; and b) an outer sheath having first and second open ends, a non-threaded inner bore and an outer surface, where the outer sheath fits over the assembled cylindrical member with the inner bore of the outer sheath in close contact with the outer surface of the cylindrical member and respective first open ends adjacent.

In one embodiment, the nut further comprises a locking element for securing the outer sheath to the cylindrical member. In a further such embodiment, the locking element engages the outer sheath and the cylindrical member at their respective second open ends.

In a different embodiment, the locking element comprises first and second locking members.

In a still different embodiment, the outer surface of the cylindrical member comprises an extension at the second open end that forms a polygon.

In a further embodiment the extension forms an extruded hexagonal top, while in a still further embodiment, the locking members engage the polygonal extension.

In a different embodiment, the outer surface of the outer sheath comprises a groove at the second end, and the locking members engage the groove.

In a further embodiment, further comprising a c-shaped retaining ring for securing the first and second locking members. In a still further aspect of that embodiment, the first and second locking members comprise an external groove, and the c-shaped retaining ring is inserted into groove of the assembled first and second locking members.

In a different embodiment, the outer surface of the sheath comprises a hexagonal surface. In another aspect, the first circumferential groove is positioned between the extruded hexagonal top and the outer wall of the inner cylindrical member.

The coupling assembly also provides a novel method of using the female nut for a coupling assembly, comprising fitting the sheath over the assembled first and second longitudinally cut cylindrical members and securing the inner cylindrical member.

In a further such embodiment, the method comprises attaching the first and second locking members having a base and a top to the sealing end of the assembled cylindrical members.

In a further such embodiment, the first and second locking members engage the inner cylindrical members and inner sheath forming an inverted hexagonal top opposite the base.

In a different embodiment, the locking members create a circumferential groove perpendicular to the longitudinal axis and positioned between the inverted hexagonal top and the base when the locking members are assembled.

In a further such embodiment, a c-shaped retaining ring and the c-shaped retaining ring are fitted into the groove of the assembled first and second locking members.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 is an exploded perspective illustrating the various components of one embodiment of the present invention.

FIG. 2 is a perspective view of the inner cylindrical member secured by the outer sheath viewed from the sealing end.

FIG. 3 is a perspective view of the inner cylindrical member secured by the outer sheath viewed from the blunt end.

FIG. 4 depicts a top view of one of the locking members.

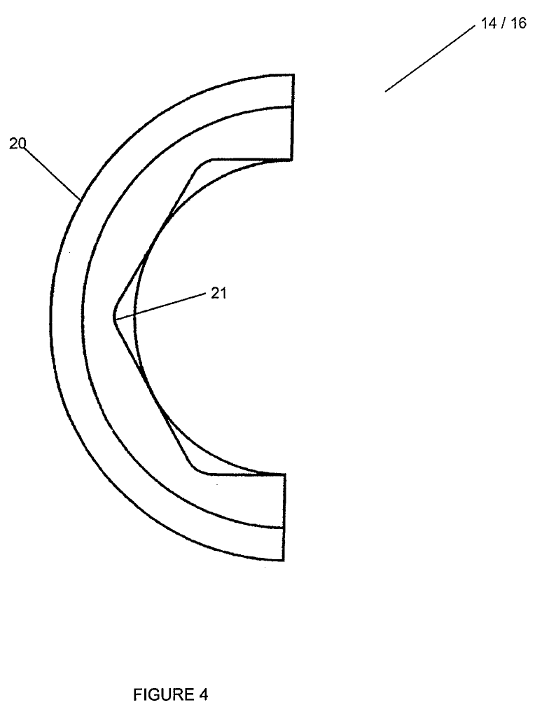

FIG. 5 depicts a side view of one of the locking members.

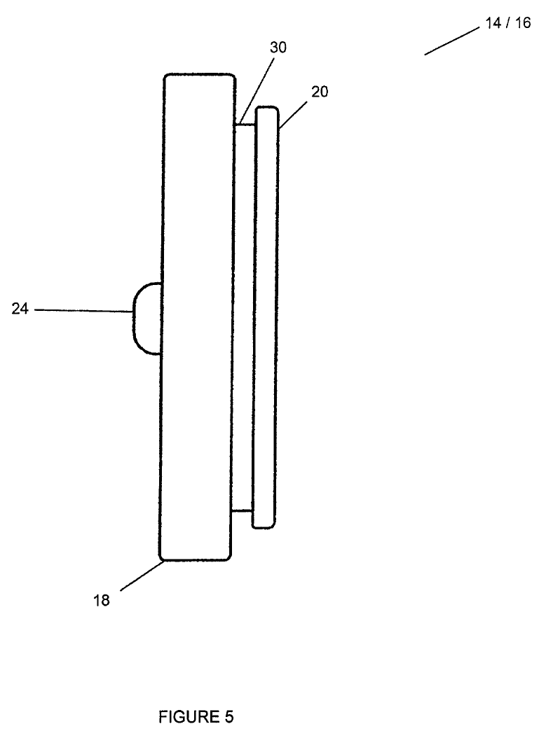

FIG. 6 depicts a bottom view of one of the locking members.

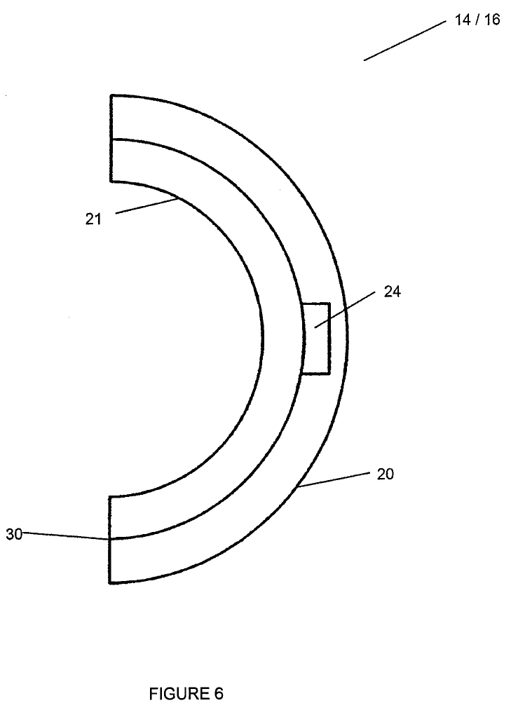

FIG. 7 depicts a top view of the assembled inner cylindrical member.

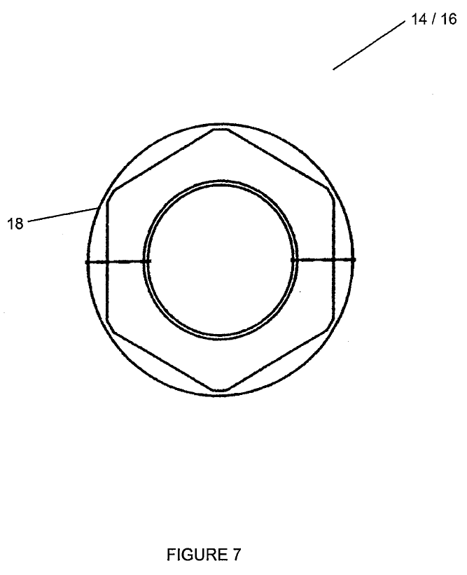

FIG. 8 depicts an inside view one of the longitudinally cut members of the inner cylindrical member.

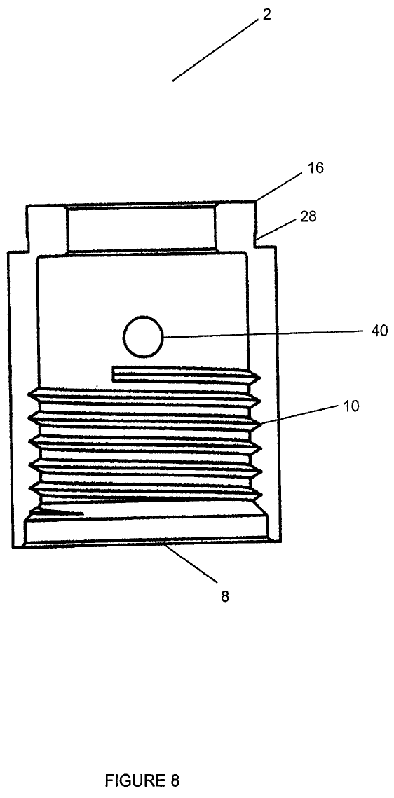

FIG. 9 depicts an inside view of the other longitudinally cut member of the inner cylindrical member.

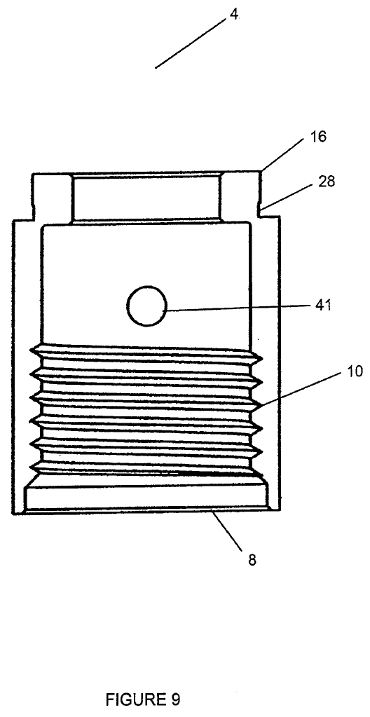

FIG. 10 depicts a bottom view of the base of the outer sheath.

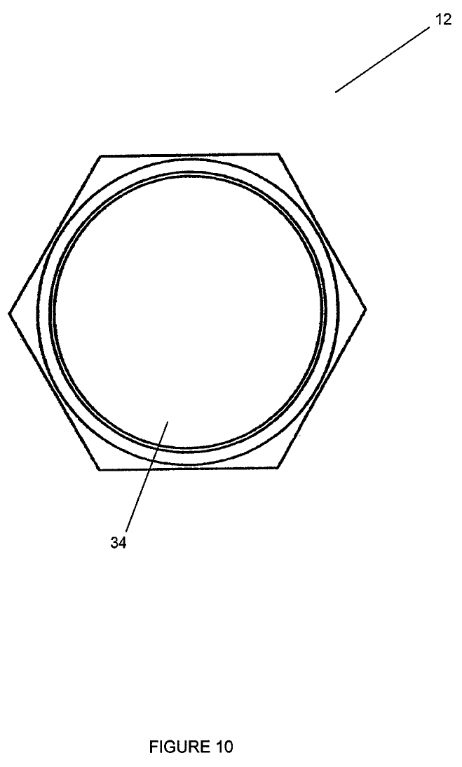

FIG. 11 depicts a side view of the outer sheath.

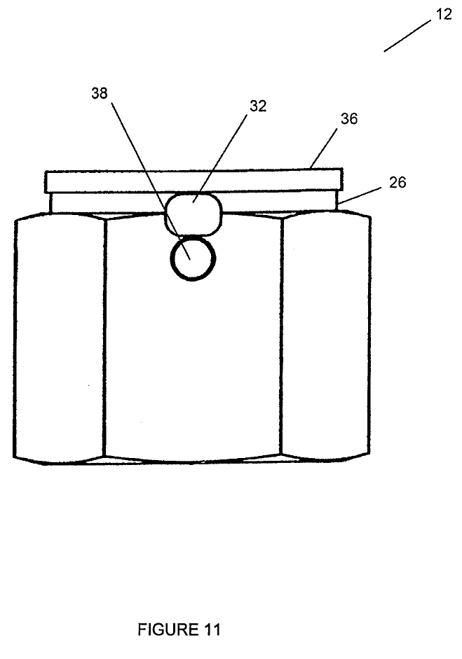

### DETAILED DESCRIPTION OF THE INVENTION

The subject invention provides an improvement in the art of the fittings and components used in high purity gas distribution systems and other ultra-high pressure systems. More particularly, the invention provides a female nut coupling system for joining a male fitting to a coupling component using a female split nut assembly to efficiently and quickly join the coupling components especially in areas with limited accessibility.

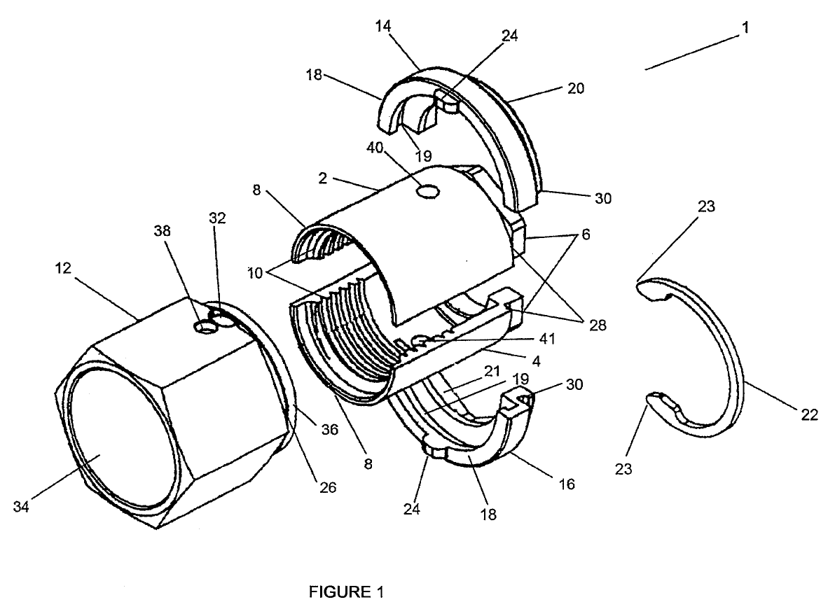

In reference to FIG. 1, which is an exploded view showing the components of the assembly, it is seen that the female nut includes a longitudinally divided inner cylinder, a sealing end, a blunt end, and a threaded inner bore. An outer sheath fits over the exterior of the female split nut securing the female nut in place.

Generally, as described above, it is desirable to have the fittings and coupling assemblies in an ultra-high pressure flow system to be formed as an integral part of the system by welding the coupling component to the flow system at the time of manufacture. When this is done, at least one of the nut components of the coupling must be installed on the coupling component prior to its being welded to the remaining portions of the flow system. This welding step sometimes requires a certain amount of additional space, thus, sometimes resulting in a flow system of larger dimensions than desired. As will be apparent from the drawing, the coupling components are easily assembled and can be welded, if necessary, even where workspace is limited.

The female nut coupling system may also utilize locking members that securely fit around the sealing end of the inner cylinder.

The female nut coupling system may also utilize a c-shaped retaining ring circumscribing the locking members.

An advantage to the invention is that is designed to be easily assembled, even in small areas, particularly when the coupling assembly requires a welding step.

Another advantage to the invention is that its dimensions are designed to be compatible with fittings already in use.

Referring now to the drawings wherein the showings are for the purposes of illustrating the preferred embodiment of the invention only and not for limiting the same.

FIG. 1 generally identifies the components of the female nut coupling assembly 19 as being comprised of a pair of first and second inner cylindrical members 2 and 4. Each of the coupling components are formed, for example, from a stainless steel. They are substantially identical and include a sealing end 6 and a blunt end 8.

The inner bore is threaded 10 to accept a male component fitting. The outer sheath 12 includes an inner bore that fits over the assembled inner cylindrical members 2 and 4 to secure the members.

The female nut assembly further includes a pair of substantially identical first and second locking members 14 and 16. The locking members 14 and 16 cooperate with the sealing end of the assembled inner cylindrical members 2 and 4.

A c-shaped retaining ring 22 may then be placed over the locking members to further secure the assembly. The c-shaped retaining ring 22 includes circular main body terminating in radially inwardly extending end flanged portions 23. It is preferred that the end flange 23 extend inwardly substantially to the outer diameter of the associated locking members 14 and 16.

Flanges 23 provide means for joining the locking members 14 and 16 in a manner that prevents axial relative movement between the c-shaped retaining ring 22 and the locking members 14 and 16.

Each locking member 14 and 16 have a flanged base 18 with an inner groove 19 to engage the sealing ends 6 of the inner cylindrical members 2 and 4.

The locking members 14 and 16 have an inverted hexagonal top 21 to encompass the extruded hexagonal top at the sealing end of the inner cylindrical members 6. Below the inverted hexagonal top 21 of the locking members 14 and 16 a second groove 30 allows a c-ring 22 or other locking structure to secure the locking members 14 and 16 in place.

The first and second inner cylindrical members 2 and 4 each have an opening 40 and 41 to provide a means to align the inner cylindrical members 2 and 4 with the corresponding opening 38 of the outer sheath 12.

The locking members 14 and 16 each have a locking tab 24 to align with the locking receptacles 32 of the outer sheath 12.

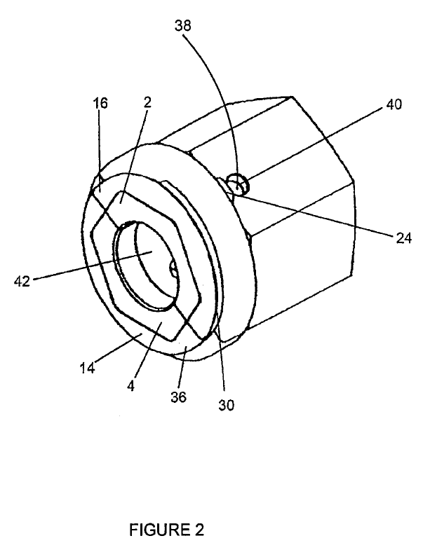

As shown in FIG. 2, the assembled inner cylindrical members 2 and 4 secured in place by the out sheath 12 and locking members 14 and 16 and viewed from the sealing end 6. The locking tabs 24 on the locking members 14 and 16 are aligned with the locking receptacles 32 of the outer sheath 12. Each of the coupling components 2, 4, 12, 14 and 16 is additionally shown as including a central cylindrical flow passage 42. Any of the components 2, 4, 14 and 16 could, in certain situations, be solid to function as an end seal.

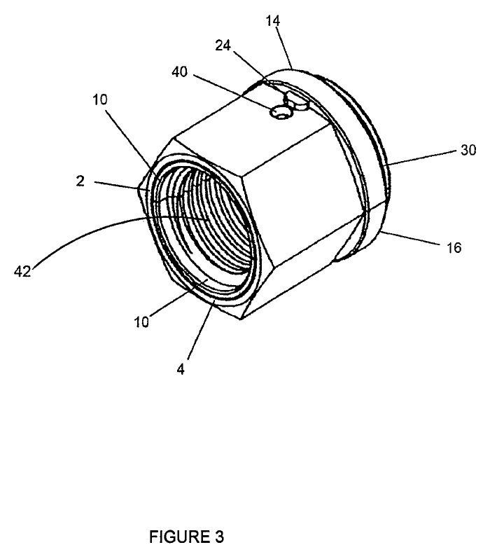

FIG. 3 demonstrates the assembled inner cylindrical members 2 and 4 secured in place by the out sheath 12 and locking members 14 and 16 and viewed from the blunt end 8 which fastens to the male component.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A female nut comprising:
a) an inner cylindrical member having first and second open ends, a threaded inner bore, and a non-threaded outer surface, wherein said cylindrical member is comprised of first and second longitudinally divided members, whereby said first and second divided members together form said cylindrical member; and
b) an outer sheath having first and second open ends, a non-threaded inner bore and an outer surface,
wherein said outer sheath fits over the assembled cylindrical member with said inner bore of said outer sheath in close contact with said outer surface of said cylindrical member and respective first open ends adjacent.

2. The nut of claim 1, further comprising a locking element for securing said outer sheath to said cylindrical member.

3. The nut of claim 2, wherein said locking element engages said outer sheath and said cylindrical member at their respective second open ends.

4. The nut of claim 3, wherein said locking element comprises first and second locking members.

5. The nut of claim 4, wherein said outer surface of said cylindrical member comprises an extension at said second open.

6. The nut of claim 5, wherein said extension forms a polygon.

7. The nut of claim 6 wherein said extension forms an extruded hexagonal top.

8. The nut of claim 5, wherein said locking members engage said polygonal extension.

9. The nut of claim 4, wherein said outer surface of said outer sheath comprises a groove at said second end, and said locking members engage said groove.

10. The nut of claim 4, further comprising a c-shaped retaining ring for securing said first and second locking members.

11. The nut of claim 10, wherein said first and second locking members comprise an external groove, and said c-shaped retaining ring is inserted into groove of the assembled first and second locking members.

12. The nut of claim 1, wherein said outer surface of said sheath comprises a hexagonal surface.

13. The nut of claim 9, wherein said first circumferential groove is positioned between the extruded hexagonal top and the outer wall of the inner cylindrical member.

14. A coupling assembly comprising the nut of claim 1.

15. A method of using a female nut for a coupling assembly, comprising:
a) an inner cylindrical member, said cylindrical member comprising first and second longitudinally divided members, each divided member having a sealing end and a blunt end, and a threaded inner bore, whereby said first and second divided members fit together to form said cylindrical member; and
b) an outer sheath having an inner bore,
wherein said sheath is fitted over the assembled first and second longitudinally cut cylindrical members securing said inner cylindrical member further comprising an extruded flanged lip forming an extruded hexagonal top.

16. The method of claim 15, further comprising first and second locking members having a base and a top, and attaching said locking members to the sealing end of the assembled cylindrical members.

17. The method of claim 16, wherein the first and second locking members engage said inner cylindrical members and inner sheath forming an inverted hexagonal top opposite said base.

18. The method of claim 17, wherein said locking members create a circumferential groove perpendicular to the longitudinal axis and positioned between said inverted hexagonal top and said base when the locking members are assembled.

19. The method of claim 18, wherein said nut further comprises a c-shaped retaining ring.

20. The method of claim 19, further comprising inserting said c-shaped retaining ring into the groove of the assembled first and second locking members.
